(19) United States
(12) Patent Application Publication
(10) Pub. No.: US 2025/0143275 A1
(43) Pub. Date: May 8, 2025

(54) BAIT RETAINING BOBBER

(71) Applicant: Brandon Johnson, Billings, MT (US)

(72) Inventor: Brandon Johnson, Billings, MT (US)

(21) Appl. No.: 18/386,672

(22) Filed: Nov. 3, 2023

(51) Int. Cl. A01K 83/00; A01K 93/00

(52) U.S. Cl. CPC A01K 97/06; A01K 83/067; A01K 93/00

(57) ABSTRACT

A bait retaining apparatus for retaining bait on a fishhook until cast into a body of water includes a container with two walls which are couplable to enclose the fishhook and bait, and which are separable upon the container striking a water surface to deposit the fishhook and the bait into the water. Floats are coupled to the container to enable the container to act as a bobber once cast into the water. Weights are coupled to the container to facilitate longer casts due to improved capacity for imparting inertia on the bait retaining apparatus.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to bait retaining apparatuses and more particularly pertains to a new bait retaining apparatus for retaining bait on a fishhook until cast into a body of water.

### (2) Description of Related Art including information disclosed under 37 CFR 1.97 and 1.98.

The prior art relates to bait retaining apparatuses which enclose a fishhook and bait mounted to the fishhook to prevent the bait from being dislodged from the fishhook. However, the prior art fails to disclose such an apparatus which is structured to open when the apparatus strikes a water surface, which enables the apparatus to retain the bait on the fishhook until after casting the fishhook into the water. The prior art also fails to disclose such an apparatus which acts as a bobber once cast into the water.

### BRIEF SUMMARY OF THE INVENTION

An embodiment of the disclosure meets the needs presented above by generally comprising a container with a first wall and a second wall which are positionable in a closed configuration with respect to each other. The first wall defines a first wall cavity in the first wall and the second wall defines a second wall cavity in the second wall. The first wall cavity and the second wall cavity define an object-receiving space between the first and second walls when the first and second walls are positioned in the closed configuration. The object-receiving space has a size such that the container is configured for containing a fishhook and bait in a retained position in the object-receiving space.

A connector is coupled to each one of the first and second walls which has a first mating member coupled to the rim of the first wall and a second mating member coupled to the rim of the second wall. The first and second mating members are releasably couplable to each other to secure the first and second walls in the closed configuration. The connector is configured to release the first and second walls from the closed configuration when the container strikes a water surface. A joining member is coupled to and extending between the first and second walls of the container to keep the first and second walls coupled when positioned in an open configuration.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a bait retaining apparatus according to an embodiment of the disclosure.

FIG. 2 is a bottom perspective view of an embodiment of the disclosure.

FIG. 3 is a front view of an embodiment of the disclosure.

FIG. 4 is a bottom perspective view of an embodiment of the disclosure.

FIG. 5 is a bottom perspective view of an embodiment of the disclosure with details of a connector depicted.

FIG. 6 is a bottom perspective in-use view of an embodiment of the disclosure.

FIG. 7 is a cross-section view of an embodiment of the disclosure taken from Arrows 7-7 in FIG. 6.

FIG. 8 is an in-use view of an embodiment of the disclosure.

FIG. 9 is an in-use view of an embodiment of the disclosure.

### DETAILED DESCRIPTION OF THE INVENTION

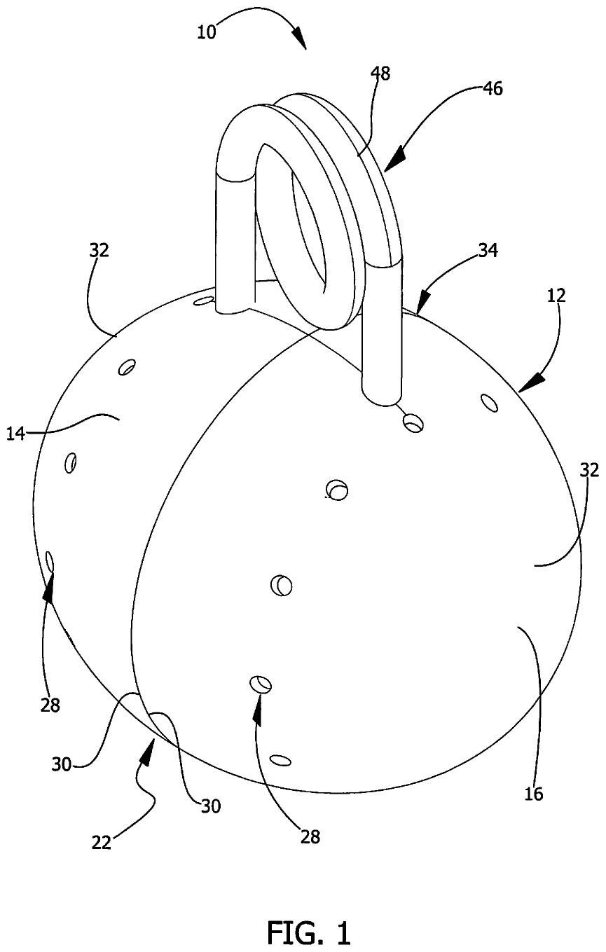

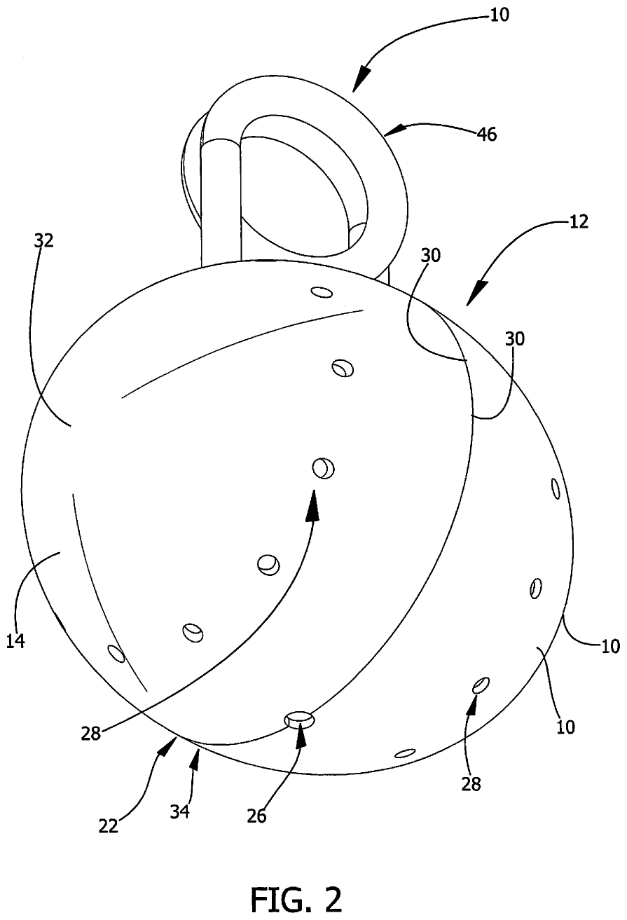

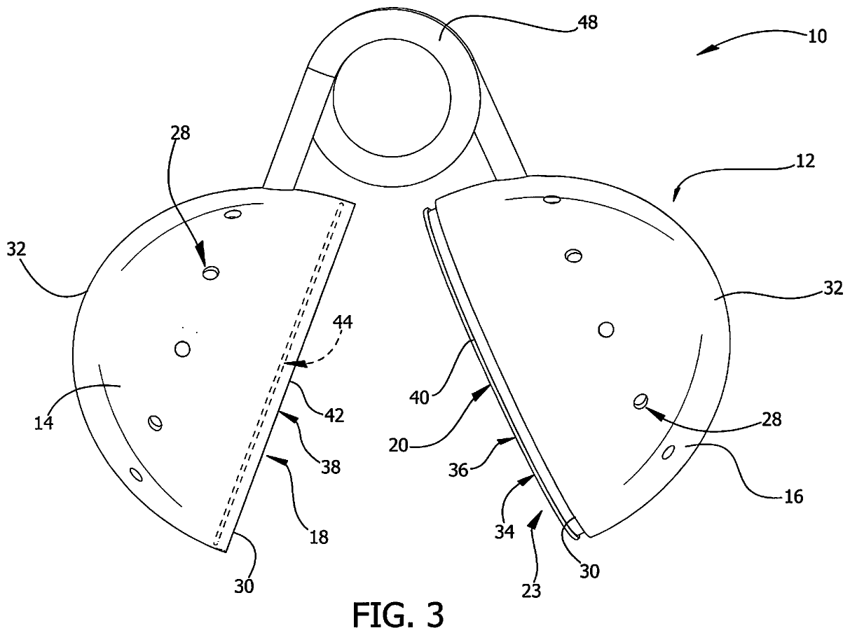

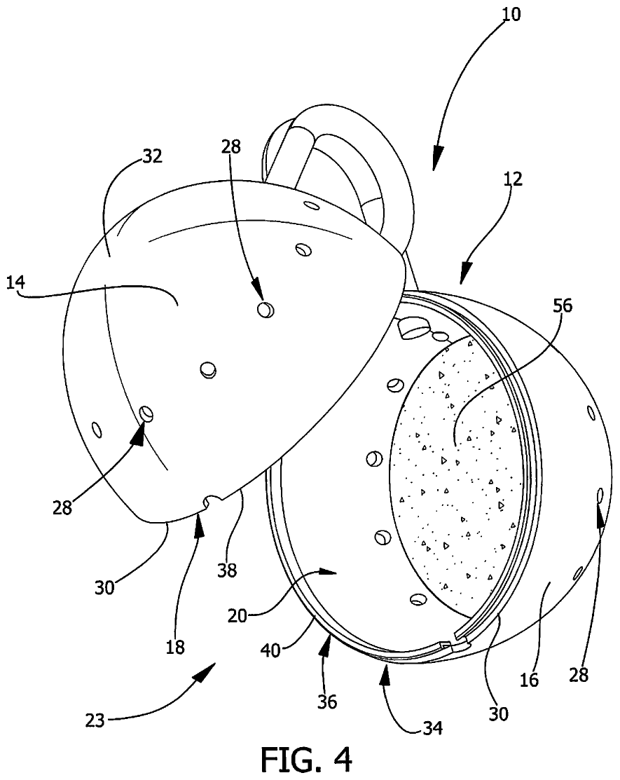

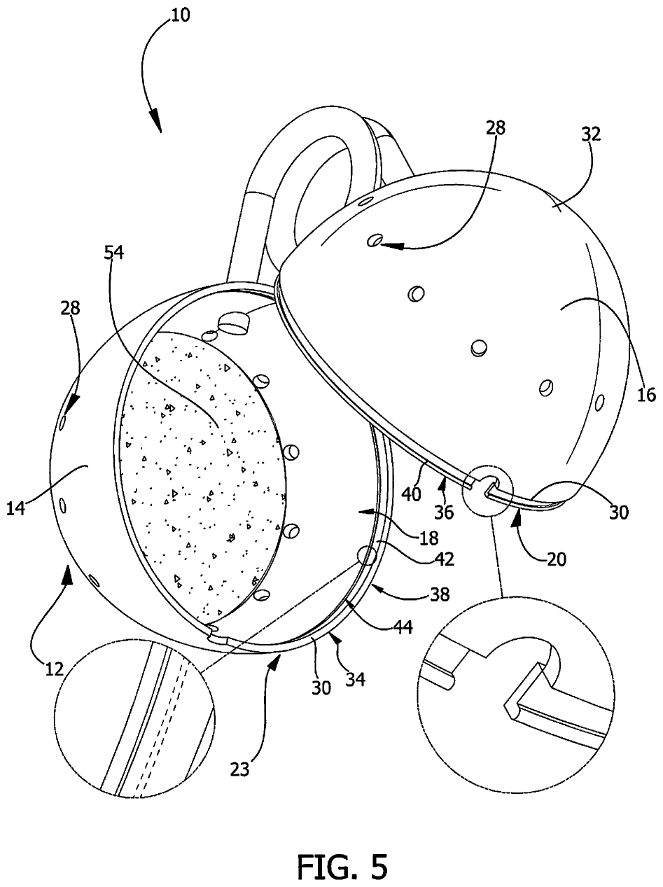

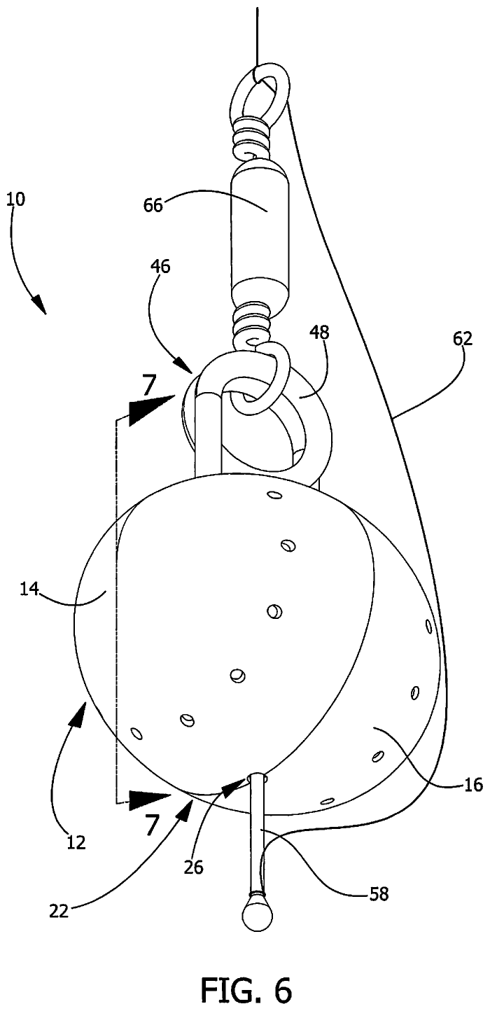

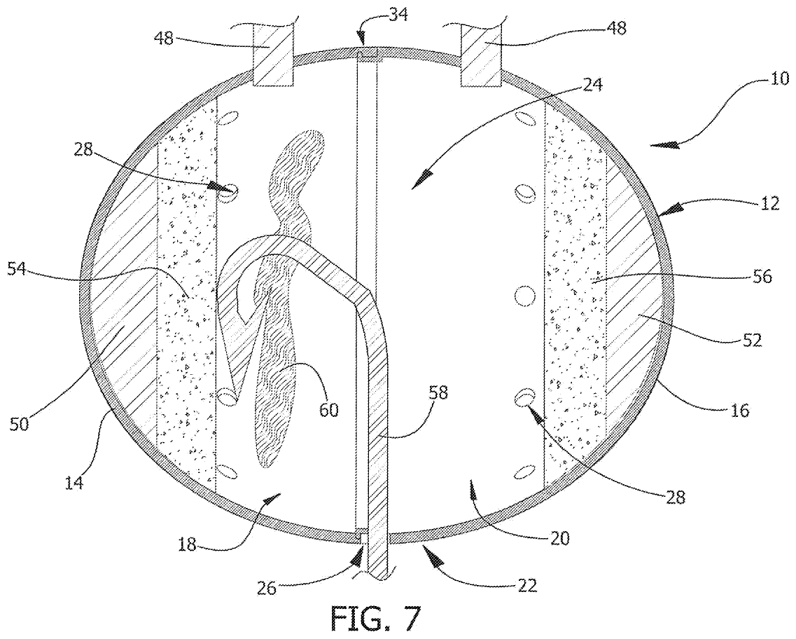

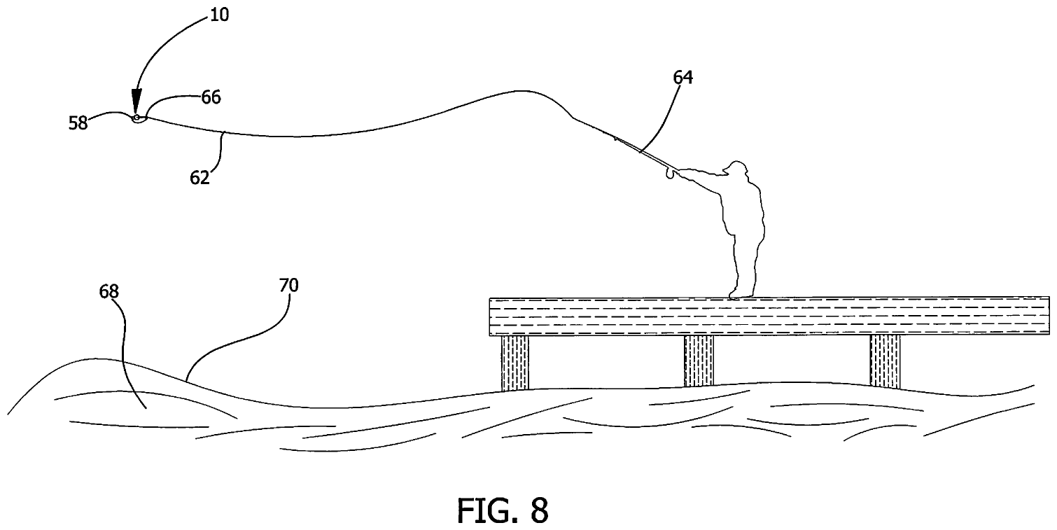

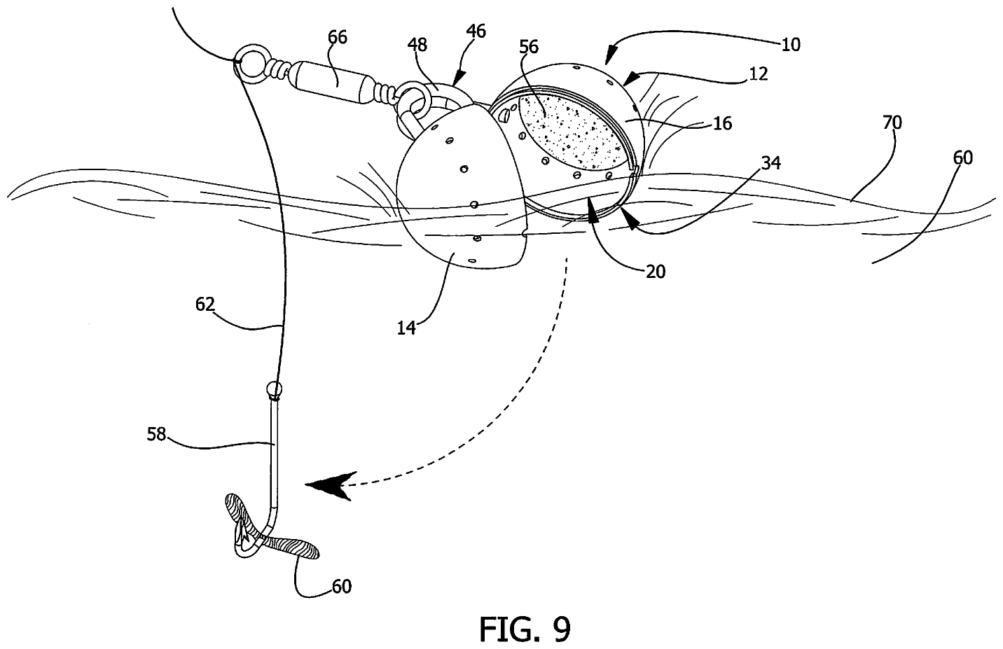

With reference now to the drawings, and in particular to FIGS. 1 through 9 thereof, a new bait retaining apparatus embodying the principles and concepts of an embodiment of the disclosure and generally designated by the reference numeral 10 will be described.

As best illustrated in FIGS. 1 through 9, the bait retaining apparatus 10 generally comprises a container 12 comprises a first wall 14 and a second wall 16 which are positionable in a closed configuration 22 with respect to each other. The first wall 14 defines a first wall cavity 18 in the first wall 14, and the second wall 16 defines a second wall cavity 20 in the second wall 16. The first wall cavity 18 and the second wall cavity 20 define an object-receiving space 24 between the first and second walls 14, 16 when the first and second walls 14, 16 are positioned in the closed configuration 22. The object-receiving space 24 has a size such that the container 12 is configured for containing a fishhook 58 and fishhook 58 in a retained position in the object-receiving space 24.

The first wall 14 and the second wall 16 also define a hook-receiving aperture 26 which extends through a rim 30 of the first wall 14 and a rim 30 of the second wall 16 when the first and second walls 14, 16 are positioned in the closed configuration 22. The hook-receiving aperture 26 has a size such that the hook-receiving aperture 26 is configured to receive the fishhook 58 when the first and second walls 14, 16 are positioned in the closed configuration 22. The size of the hook-receiving aperture 26 is such that the fishhook 58 is not readily removable from the object-receiving space 24 through the hook-receiving aperture 26 when the first and second walls 14, 16 are in the closed configuration 22. The first and second walls 14, 16 may clamp or otherwise secure the fishhook 58 in the hook-receiving aperture 26.

Each one of the first and second wall 16 defines a plurality of drain holes 28 which extend therethrough to the first wall cavity 18 and second wall cavity 20 respectively. Each one of the first and second wall 16 has a dome shape such that the container 12 has an ellipsoid shape. A major axis of the container 12 extends from a closed end 32 of the first wall 14 to a closed end 32 of the second wall 16.

A connector 34 is coupled to each one of the first and second walls 14, 16. The connector 34 has a first mating member 36 coupled to the rim 30 of the first wall 14 and a second mating member 38 coupled to the rim 30 of the second wall 16. The first and second mating members 38 are releasably couplable to each other to secure the first and second walls 14, 16 in the closed configuration 22. The connector 34 comprises a snap joint which is configured to couple with a force such that the snap joint releases the first and second walls 14, 16 from the closed configuration 22 when the container 12 strikes a water surface 70. The first mating member 36 comprises a ridge 40, and the second mating member 38 comprises a receiver 42 which defines a groove 44 in the receiver 42. In other embodiments, the connector 34 may be of another suitable type such that the connector 34 releases the first and second walls 14, 16 from the closed configuration 22 when the container 12 strikes a water surface 70. For example, the connector 34 may comprise a magnetic fastener, an adhesive, or the like.

A joining member 46 is coupled to and extends between the first and second walls 14, 16 of the container 12. The joining member 46 comprises a cord 48 but may comprise a hinge, a spring, or the like. The joining member 46 serves to keep the first and second walls 14, 16 connected to each other when the first and second walls 14, 16 are positioned in an open configuration 23. A first weight 50 is mounted in the first wall cavity 18 of the first wall 14 of the container 12, and a second weight 52 is mounted in the second wall cavity 20 of the second wall 16 of the container 12. The first weight 50 is positioned adjacent to the closed end 32 of the first wall 14, and the second weight 52 is positioned adjacent to the closed end 32 of the second wall 16. The first weight 50 and the second weight 52 provide sufficient mass such that, when the bait retaining apparatus 10 is launched, the bait retaining apparatus 10 will have enough inertia to avoid excessive deceleration caused by air resistance.

A first float 54 is mounted in the first wall cavity 18 of the first wall 14 of the container 12, and a second float 56 is mounted in the second wall cavity 20 of the second wall 16 of the container 12. The first float 54 is positioned opposite the closed end 32 of the first wall 14 across the first weight 50, and the second float 56 is positioned opposite the closed end 32 of the second wall 16 across the second weight 52. The drain holes 28 of the first wall 14 are radially spaced with respect to each other and are positioned adjacent to the first float 54. The drain holes 28 of the second wall 16 are radially spaced with respect to each other and are positioned adjacent to the second float 56. The first float 54 has a density such that the first float 54 is configured to cause the first wall 14 and the first weight 50 to be buoyant in water 68, and the second float 56 has a density such that the second float 56 is configured to cause the second wall 16 and the second weight 52 to be buoyant in water 68.

In use, the bait retaining apparatus 10 is attached to a fishing line 62, which may be mounted on a fishing pole 64 or other fishing apparatus 10. The fishing line 62 may be attached in various ways, such as being tied around the joining member 46 or being tied to a fishing swivel 66 which is connected to the joining member 46. The container 12 is closed around the fishhook 58, which is also attached to the fishing line 62, and the fishhook 58, which is mounted to the fishhook 58, by connecting the first and second walls 14, 16 with the connector 34. The fishhook 58 extends through the hook-receiving aperture 26. In some embodiments, the fishhook 58 may reside solely within the container 12, and the fishing line 62 will instead extend through the hook-receiving aperture 26. The bait retaining apparatus 10 then retains the fishhook 58 on the fishhook 58 by guarding the fishhook 58 from external perturbances. The container 12 remains closed until a sufficient force is applied to open it, such as when the container 12 is cast against the water surface 70.

After impacting the water surface 70, the container 12 opens and allows the fishhook 58 to be released into the water 68. The first and second walls 14, 16 are buoyed by the first float 54 and the second float 56 respectively, which thereby acts as a traditional bobber by suspending the fishhook 58 from the water surface 70 and indicating that a fish has bit the fishhook 58 when it drops below the water surface 70. Water 68 flows freely through the drain holes 28 to inhibit the water 68 from becoming trapped in the first wall cavity 18 or the second wall cavity 20 and weighing the first or second wall 14, 16 down.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A bait retaining apparatus for retaining bait on a fishhook while casting the bait into a body of water, the apparatus comprising:
a container comprising a first wall and a second wall, the first wall and the second wall being positionable in a closed configuration with respect to each other, the first wall defining a first wall cavity in the first wall, the second wall defining a second wall cavity in the second wall, the first wall cavity and the second wall cavity defining an object-receiving space between the first and second walls when the first and second walls are positioned in the closed configuration, the object-receiving space having a size such that the container is configured for containing the fishhook and the bait in a retained position in the object-receiving space;
a connector being coupled to each one of the first and second walls, the connector having a first mating member coupled to the rim of the first wall and a second mating member coupled to the rim of the second wall, the first and second mating members being releasably couplable to each other to secure the first and second walls in the closed configuration, the connector being configured to release the first and second walls from the closed configuration when the container strikes a water surface; and
a joining member being coupled to and extending between the first and second walls of the container, wherein the joining member comprises a cord, the cord having a coiled medial section defining a loop extending from the container.

2. The apparatus of claim 1, wherein the first wall and the second wall define a hook-receiving aperture which extends through a rim of the first wall and a rim of the second wall when the first and second walls are positioned in the closed configuration, the hook-receiving aperture having a size such that the hook-receiving aperture is configured to receive the fishhook when the first and second walls are positioned in the closed configuration.

3. The apparatus of claim 1, wherein each one of the first and second wall defines a plurality of drain holes extending therethrough to the first wall cavity and second wall cavity respectively.

4. The apparatus of claim 1, wherein each one of the first and second wall has a dome shape.

5. The apparatus of claim 4, wherein the container has an ellipsoid shape, a major axis of the container extending from a closed end of the first wall to a closed end of the second wall.

6. The apparatus of claim 1, wherein the connector comprises a snap joint, the snap joint being configured to couple with a force such that the snap joint releases the first and second walls from the closed configuration when the container strikes a water surface.

7. The apparatus of claim 6, wherein the first mating member comprises a ridge, the second mating member comprising a receiver which defines a groove in the receiver.

8. (canceled)

9. The apparatus of claim 1, further comprising a first weight and a second weight, the first weight being mounted in the first wall cavity of the first wall of the container, the second weight being mounted in the second wall cavity of the second wall of the container.

10. The apparatus of claim 9, further comprising a first float and a second float, the first float being mounted in the first wall cavity of the first wall of the container, the second float being mounted in the second wall cavity of the second wall of the container, the first float having a density such that the first float is configured to cause the first wall and the first weight to be buoyant in water, the second float having a density such that the second float is configured to cause the second wall and the second weight to be buoyant in water.

11. A bait retaining apparatus for retaining bait on a fishhook while casting the bait into a body of water, the apparatus comprising:
a container comprising a first wall and a second wall, the first wall and the second wall being positionable in a closed configuration with respect to each other, the first wall defining a first wall cavity in the first wall, the second wall defining a second wall cavity in the second wall, the first wall cavity and the second wall cavity defining an object-receiving space between the first and second walls when the first and second walls are positioned in the closed configuration, the object-receiving space having a size such that the container is configured for containing the fishhook and the bait in a retained position in the object-receiving space, the first wall and the second wall defining a hook-receiving aperture which extends through a rim of the first wall and a rim of the second wall when the first and second walls are positioned in the closed configuration, the hook-receiving aperture having a size such that the hook-receiving aperture is configured to receive the fishhook when the first and second walls are positioned in the closed configuration, each one of the first and second wall defining a plurality of drain holes extending therethrough to the first wall cavity and second wall cavity respectively, each one of the first and second wall having a dome shape, the container having an ellipsoid shape, a major axis of the container extending from a closed end of the first wall to a closed end of the second wall;
a connector being coupled to each one of the first and second walls, the connector having a first mating member coupled to the rim of the first wall and a second mating member coupled to the rim of the second wall, the first and second mating members being releasably couplable to each other to secure the first and second walls in the closed configuration, the connector comprising a snap joint, the snap joint being configured to couple with a force such that the snap joint releases the first and second walls from the closed configuration when the container strikes a water surface, the first mating member comprising a ridge, the second mating member comprising a receiver which defines a groove in the receiver;
a joining member being coupled to and extending between the first and second walls of the container, the joining member comprising a cord, the cord having a coiled medial section defining a loop extending from the container;
a first weight and a second weight, the first weight being mounted in the first wall cavity of the first wall of the container, the second weight being mounted in the second wall cavity of the second wall of the container, the first weight being positioned adjacent to the closed end of the first wall, the second weight being positioned adjacent to the closed end of the second wall; and
a first float and a second float, the first float being mounted in the first wall cavity of the first wall of the container, the second float being mounted in the second wall cavity of the second wall of the container, the first float being positioned opposite the closed end of the first wall across the first weight, the second float being positioned opposite the closed end of the second wall across the second weight, the plurality of drain holes of the first wall being radially spaced with respect to each other and being positioned adjacent to the first float, the plurality of drain holes of the second wall being radially spaced with respect to each other and being positioned adjacent to the second float, the first float having a density such that the first float is configured to cause the first wall and the first weight to be buoyant in water, the second float having a density such that the second float is configured to cause the second wall and the second weight to be buoyant in water.
